(19) United States
(12) Patent Application Publication
(10) Pub. No.: US 2019/0085786 A1
(43) Pub. Date: Mar. 21, 2019

(54) ALUMINUM CYLINDER BLOCK ASSEMBLIES AND METHODS OF MAKING THE SAME

(71) Applicant: GM GLOBAL TECHNOLOGY OPERATIONS LLC, Detroit, MI (US)

(72) Inventors: Ronald J. Petrus, Lake Orion, MI (US); Martin S. Kramer, Davisburg, MI (US)

(21) Appl. No.: 15/708,272

(22) Filed: Sep. 19, 2017

(51) Int. Cl. F02F 1/00; F02F 7/00; B22D 19/00; C22C 21/02; C23C 4/06

(52) U.S. Cl. CPC F02F 1/004; F02F 7/0085; F02F 7/0095; F02F 2200/06; C22C 21/02; C23C 4/06; B22D 19/0009

(57) ABSTRACT

Engine block assemblies and methods for making the same are provided. Methods include casting an engine block around one or more extruded aluminum cylindrical cylinder liners, wherein each cylinder liner includes a cylindrical inner surface and an outer surface, and the outer surface of each of the cylinder liners is contiguous with the engine block and defines a cylinder bore, subsequently surface-preparing the inner surface of each of the cylinder liners, subsequently applying a ferrous liner to an inner side of each of the cylinder liners via thermal spraying, and subsequently machining an inner surface of the ferrous liner. Each of the aluminum cylinder liners are extruded, and can comprise a low silicon content aluminum alloy. The engine block can comprise a high silicon content aluminum alloy. Each of the one or more ferrous liners comprises a thickness of less than about 175 microns.

During a combustion cycle of an internal combustion engine (ICE), air/fuel mixtures are provided to cylinders within an engine block of the ICE. The air/fuel mixtures are compressed and/or ignited and combusted to provide output torque via pistons positioned within the cylinders. As the pistons move within the cylinders, friction between the piston and cylinder and the presence of fuel can wear and degrade the cylinder surfaces. Additionally, combustion pressure and piston side loading can pose significant amount of stresses on the cylinder bores.

Aluminum engine blocks can provide benefits such as improved fuel economy due to the lighter weight of aluminum engines and better engine performance and reliability due to reduced bore distortion and improved heat transfer through aluminum cylinder bores. Aluminum bore engines also allow tighter clearance between piston and cylinder bore, leading to a reduction in engine noise and oil consumption. However, casted aluminum engine blocks can exhibit low wear resistance against reciprocating pistons and appurtenant components.

### SUMMARY

According to an aspect of an exemplary embodiment a method for manufacturing an engine block assembly is provided. The method can include casting an engine block around one or more aluminum cylindrical cylinder liners, wherein each aluminum cylinder liner includes a cylindrical inner surface and an outer surface, and the outer surface of each of the aluminum cylinder liners is contiguous with the engine block and defines a cylinder bore, and applying a ferrous liner to the inner surface of each of the aluminum cylinder liners via thermal spraying. The method can further include surface-preparing the inner surface of each of the aluminum cylinder liners prior to applying the ferrous liner to an inner side of each of the aluminum cylinder liners. The method can further include, subsequent to applying a ferrous liner to an inner side of each of the aluminum cylinder liners, machining an inner surface of the ferrous liner. Each of the aluminum cylinder liners can include a low silicon content aluminum alloy. Each of the aluminum cylinder liners can include an International Alloy Designation System 6000 series aluminum alloy. Each of the aluminum cylinder liners can include an International Alloy Designation System 6005 aluminum alloy, a 6061 aluminum alloy, or a 6063 aluminum alloy. Each of the aluminum cylinder liners can be extruded. The engine block can include a high silicon content aluminum alloy. The engine block can include an International Alloy Designation System 4000 series aluminum alloy or an American National Standards Institute 300 series aluminum alloy. The ferrous liner can be applied using rotating single wire, twin wire arc, atmospheric plasma spray, or high velocity oxyfuel thermal spraying methods.

According to an aspect of an exemplary embodiment an engine block assembly is provided. The engine block assembly can include a cast aluminum engine block comprising one or more cylinder bores, wherein each of the cylinder bores defines a bore surface, one or more aluminum cylinder liners disposed within the one or more cylinder bores such that an outer surface of each aluminum cylinder liner is disposed contiguous with a bore surface of each cylinder bore, and a ferrous liner applied to an inner surface of each of the one or more aluminum cylinder liners via thermal spraying. Each of the one or more aluminum cylinders are cast in place during casting of the aluminum engine block. Each of the one or more ferrous liners can have a thickness of less than about 175 microns. Each of the aluminum cylinder liners can include a low silicon content aluminum alloy. Each of the aluminum cylinder liners can include an International Alloy Designation System 6000 series aluminum alloy. Each of the aluminum cylinder liners can include an International Alloy Designation System 6005 aluminum alloy, a 6061 aluminum alloy, or a 6063 aluminum alloy. Each of the one or more aluminum cylinder liners can be extruded. The engine block can include a high silicon content aluminum alloy. An inner surface of each of the one or more ferrous liners can be machined after being applied to an inner side of each of the corresponding one or more aluminum cylinder liners.

According to an aspect of an exemplary embodiment a method for manufacturing an engine block assembly is provided. The method can include casting an engine block around one or more extruded aluminum cylindrical cylinder liners, wherein each aluminum cylinder liner includes a cylindrical inner surface and an outer surface, and the outer surface of each of the aluminum cylinder liners is contiguous with the engine block and defines a cylinder bore, subsequently surface-preparing the inner surface of each of the aluminum cylinder liners, subsequently applying a ferrous liner to an inner side of each of the aluminum cylinder liners via thermal spraying, and subsequently machining an inner surface of the ferrous liner. Each of the one or more ferrous liner can have a thickness of less than about 175 microns.

Other objects, advantages and novel features of the exemplary embodiments will become more apparent from the following detailed description of exemplary embodiments and the accompanying drawings.

### BRIEF DESCRIPTION OF THE DRAWINGS

FIG. 1 illustrates a side view of an engine block assembly, according to one or more embodiments;

FIG. 2 illustrates a cross-sectional side view of engine block assembly proximate to a cylinder bore, according to one or more embodiments; and

FIG. 3 illustrates a method for manufacturing an engine block assembly, according to one or more embodiments.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

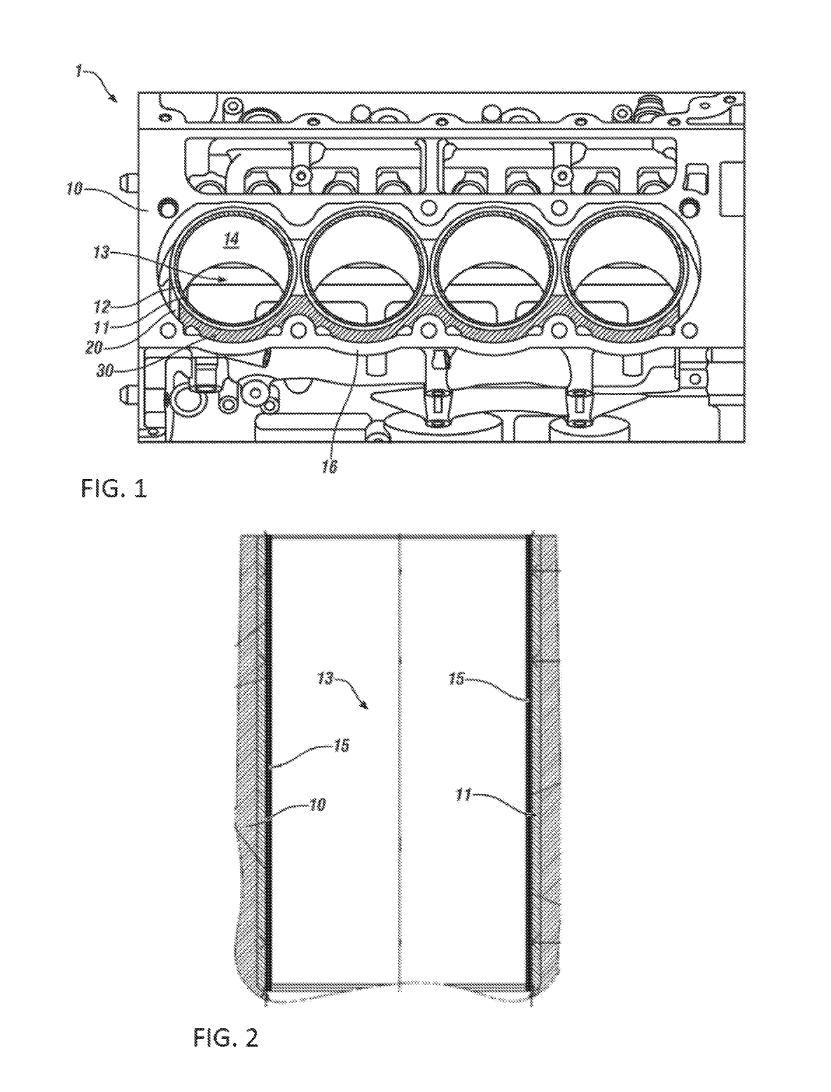

Referring now to the drawings, wherein like numerals indicate like elements throughout various views, FIG. 1 illustrates a top plan view of a multi-cylinder engine block assembly 1. Engine block assembly 1 includes a cast engine block 10 having a plurality of cylindrical openings forming cylinder walls 12 that define a corresponding plurality of cylinder bores 13. As shown, the plurality of cylinder bores 13 includes four of the cylinder bores 13 disposed in series, however varying numbers and configurations of cylinder bores are conceived as within the scope of this disclosure. The engine block 10 comprises aluminum. A cylindrically-shaped, aluminum cylinder liner 11 is disposed within each of the cylinder bores 13. An outer surface of the aluminum cylinder liner 11 is contiguous with the cylinder wall 12 of the corresponding cylinder bore 13. The aluminum cylinder liner 11 is cylindrical in that its inner surface 14 defines a cylindrical cavity, and While the outer surface of the aluminum cylinder liner 11 is illustrated as generally cylindrical, other configurations are practicable and within the scope of this disclosure. The aluminum cylinder liner 11 comprises aluminum. Further illustrated in FIG. 1 are optional features of engine block assembly 1. For example, outer engine block walls 16 can be formed peripheral to outer surfaces of the plurality of the cylinder walls 12 with a channel 20 formed therebetween. The channel 20 can provide a void area for a water jacket to encompass an upper portion of the outer peripheral surfaces of the cylinder walls 12, for example. FIG. 2 illustrates a cross-sectional side view of engine block assembly 1 proximate to a cylinder bore 13. Engine block assembly I further comprises ferrous liner 15, such as a thermally sprayed steel, applied to the inner surface 14 of the aluminum cylinder liner 11. Ferrous liner 15 includes an outer surface contiguous with the inner surface of the aluminum cylinder liner 11, and an inner surface that defines a cylindrical cavity.

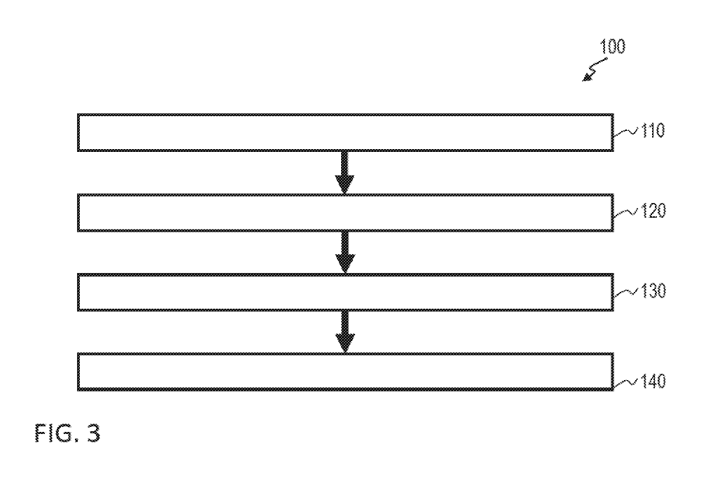

FIG. 3 illustrates a method 100 for manufacturing an engine block assembly 1. Method 100 will be described in reference to FIGS. 1-2 for the sake of clarity, but method 100 is not intended to be limited thereby. Method 100 comprises casting 110 an engine block 10 around one or more aluminum cylinder liners 11, and applying 130 a ferrous liner 15 to the inner surface 14 of each aluminum cylinder liner 11 via thermal spraying. Method 100 can optionally include surface-preparing 120 the inner surface 14 of one or more aluminum cylinder liners 11 prior to applying 130 the ferrous liner 15 thereto. Preparing 120 the inner surface 14 of one or more aluminum cylinder liners 11 can occur subsequent to casting 110 the engine block 10 around the one or more aluminum cylinder liners 11, in some embodiments. Surface-preparing 120 the inner surface 14 of one or more aluminum cylinder liners 11 can include roughening the inner surface 14 of the one or more aluminum cylinder liners 11, or otherwise creating irregular structures such as ribs or dove tails to enhance the adhesion of the ferrous liner 15 thereto. Method 100 can optionally further include, subsequent to applying 130 the ferrous liner 15 to the inner surface 14 of one or more aluminum cylinder liners 11, machining 140 the inner surface of the ferrous liner 15. The inner surface of the ferrous liner 15 can be machined to desired specifications, such as to accommodate reciprocation of a piston within the cylinder bore 13, for example.

Engine block 10 comprises a cast aluminum material, such as pure aluminum or an aluminum alloy. As used herein, a “pure” material is considered to include minor levels of impurities, such as those tolerated by industry. Generally aluminum alloys will include one or more of silicon, magnesium, manganese, iron, and copper, among others. The particular aluminum alloy composition may depend on the method of manufacture of the engine block 10. Engine block 10 can he sand cast or die cast. Sand casting generally includes creating void in the shape of a desired article within a body of sand. The void is subsequently tilled with molten liquid metal which is allowed to cool and solidify. Die casting generally includes forcing molten metal into a die under pressure. Casted aluminum engine blocks 10 can comprise high silicon content, such as about 5% silicon to about 25% silicon. Suitable aluminum alloys are taught in co-owned U.S. Pat. No. 6,921,512, the disclosure of which is herein incorporated in its entirety. High silicon aluminum alloys can include an International Alloy Designation System (IADS) 4000 series and American National Standards Institute (ANSI) 300 series aluminum alloys, for example. In one example, suitable high silicon alloys can include LADS 4032 and 4047 alloys. One example of a high silicon alloy suitable for sand casting is the ANSI 319 alloy. One example of a high silicon alloy suitable for die casting is the ANSI 380 alloy.

The aluminum cylinder liners 11 comprise an extruded aluminum material, such as an aluminum alloy. Generally aluminum alloys will include one or more of silicon, magnesium, manganese, iron, and copper, among others. Extruded aluminum cylinder liners 11 can comprise lower silicon content relative to the aluminum alloys of engine block 10, such as less than about 2%. For example, extruded aluminum cylinder liners 11 can comprise about 0.01% to about 2% silicon. Extruded aluminum cylinder liners 11 utilize aluminum materials which exhibit high strength and stiffness. Suitable aluminum alloys include IADS 6000 series aluminum alloy's, for example. In one example, suitable high silicon alloys can include IADS 6005, 6061, and 6063 alloys. The aluminum alloys used to fabricate the one or more aluminum cylinder liners will be relatively stronger than the aluminum alloys used to fabricate the engine block 10. Accordingly, the one or more aluminum cylinder liners 11 will stiffen and generally enhance the mechanical properties of the engine block 10. The strong and stiff material of the aluminum cylinder liner 11 reduces bore distortion, oil consumption, and blow by of engine block assembly 1. Further, the materials described above reduce bore bridge recession. By virtue of their aluminum alloy compositions, engine block 10 and aluminum cylinder liner 11 will exhibit similar thermal expansion coefficients thereby minimizing bore distortion, for example. Casting 110 can include positioning the one or more aluminum cylinder liners 11 within a casting mold prior to the introduction of the molten aluminum alloy that will form the engine block 10.

Each of the one or more ferrous liners 15 can comprises a steel alloy. Suitable steel alloy compositions can include low to medium carbon, and optionally magnesium, chromium, and molybdenum, among other elements. The steel alloy must be suitable for the deposition process utilized to apply 130 the one or more ferrous liners 15. The one or more ferrous liners 15 can be applied 130 using various thermal spray methods including rotating single wire (RSW), twin wire arc (TWA), atmospheric plasma spray (APS), and high velocity oxyfuel (HVOF), among others. The one or more ferrous liners 15 are optionally machined 140 in order to obtain a desired inner contour and wall thickness. In some embodiments, the one or more ferrous liners 15 are thin, and comprise thicknesses of up to about 200 microns, or up to about 175 microns. In some embodiments, the one or more ferrous liners 15 comprise thicknesses of about 100 microns to about 200 microns. In one specific, embodiment, the one or more ferrous liners 15 comprise thicknesses of about 150 microns. The thin ferrous liners 15 exhibit low thermal expansion by virtue of their physical dimensions, and exhibit high adhesion to their respective aluminum cylinder liners 11 under extreme operating conditions. The one or more ferrous liners 15 further provide enhanced wear resistance relative to the aluminum liner 11, for example against reciprocating pistons.

Method 100 advantageously allows a previously existing die or mold to be utilized to cast new and/or various engine block assemblies 1. For example, an existing die or mold designed to cast a linerless aluminum engine block or an aluminum block incorporating a thermally sprayed ferrous liner can be utilized to implement method 100 thereby obviating the need for expensive and time consuming design and retooling of new dies or molds. Dies and molds must be carefully designed to control the physical characteristics of a casted part (e.g., an engine block), such as porosity. However, method 100 both assists in controlling (i.e., minimizing) the porosity of a block during casting and accommodates higher-porosity engine blocks 10 by virtue of the enhanced mechanical properties (e.g., strength, stiffness) of the extruded aluminum cylinder liners 11. Further, the engine block 1 casting conditions need not be optimized to provide cylinder bore surface properties which accommodate the application of a thermally sprayed ferrous liner thereto, as the requisite surface properties need only he achieved on the inner surface 14 of the one or more aluminum cylinder liners 11.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A method for manufacturing an engine block assembly, the method comprising:
casting an engine block around one or more aluminum cylindrical cylinder liners, wherein each aluminium cylinder liner includes a cylindrical inner surface and an outer surface, and the outer surface of each of the aluminum cylinder liners is contiguous with the engine block and defines a cylinder bore; and
applying a ferrous liner to the inner surface of each of the aluminum cylinder liners via thermal spraying.

2. The method of claim 1, further comprising surface-preparing the inner surface of each of the one or more aluminum cylinder liners prior to applying the ferrous liner to an inner side of each of the aluminum cylinder liners.

3. The method of claim 1, further comprising, subsequent to applying a ferrous liner to an inner side of each of the aluminum cylinder liners, machining an inner surface of the ferrous liner.

4. The method of claim 1, wherein each of the one or more aluminum cylinder liners comprises a low silicon content aluminum alloy.

5. The method of claim 1, wherein each of the aluminum cylinder liners comprises an International Alloy Designation System 6000 series aluminum alloy.

6. The method of claim 1, wherein each of the aluminum cylinder liners comprises an International Alloy Designation System 6005 aluminum alloy, a 6061 aluminum alloy, or a 6063 aluminum alloy.

7. The method of claim 1, wherein each of the aluminum cylinder liners is extruded.

8. The method of claim 1, wherein the engine block comprises a high silicon content aluminum alloy.

9. The method of claim 1, wherein the engine block comprises an International Alloy Designation System 4000 series aluminum alloy or an American National Standards Institute 300 series aluminum alloy.

10. The method of claim 1, wherein the ferrous liner is applied using rotating single wire, twin wire arc, atmospheric plasma spray, or high velocity oxyfuel thermal spraying methods.

11. An engine block assembly comprising:
a cast aluminum engine block comprising one or more cylinder bores, wherein each of the cylinder bores defines a bore surface;
one or more aluminum cylinder liners disposed within each of the one or more cylinder bores such that an outer surface of each aluminum cylinder liner is disposed contiguous with a bore surface of each cylinder bore; and
a ferrous liner applied to an inner surface of each of the one or more aluminum cylinder liners via thermal spraying,
wherein each of the one or more aluminum cylinders are cast in place during casting of the aluminum engine block.

12. The engine block assembly of claim 11, wherein each of the one or more ferrous liners comprises a thickness of less than about 175 microns.

13. The engine block assembly of claim 11, wherein each of the aluminum cylinder liners comprises a low silicon content aluminum alloy.

14. The engine block assembly of claim 11, wherein each of the aluminum cylinder liners comprises an International Alloy Designation System 6000 series aluminum alloy.

15. The engine block assembly of claim 11, wherein each of the aluminum cylinder liners comprises an International Alloy Designation System 6005 aluminum alloy, a 6061 aluminum alloy, or a 6063 aluminum alloy.

16. The engine block assembly of claim 11, wherein each of the one or more aluminum cylinder liners is extruded.

17. The engine block assembly of claim 11, wherein the engine block comprises a high silicon content aluminum alloy.

18. The engine block assembly of claim 11, wherein an inner surface of each of the one or more ferrous liners is machined after being applied to an inner side of each corresponding one or more aluminum cylinder liners.

19. A method for manufacturing an engine block assembly, the method comprising:
casting an engine block around one or more extruded aluminum cylindrical cylinder liners, wherein each aluminum cylinder liner includes a cylindrical inner surface and an outer surface, and the outer surface of each of the aluminum cylinder liners is contiguous with the engine block and defines a cylinder bore;
subsequently surface-preparing the inner surface of each of the aluminum cylinder liners;
subsequently applying a ferrous liner to an inner side of each of the aluminum cylinder liners via thermal spraying; and
subsequently machining an inner surface of the ferrous liner.

20. The method of claim 19, wherein each of the one or more ferrous liners comprises a thickness of less than about 175 microns.
